(19) United States
(12) Patent Application Publication
(10) Pub. No.: US 2017/0127165 A1
(43) Pub. Date: May 4, 2017

(54) AUTOMOTIVE AUDIO COMMUNICATION SYSTEM

(71) Applicant: Panasonic Automotive Systems Company of America, Division of Panasonic Corporation of North America, Peachtree City, GA (US)

(72) Inventor: PADMANABAN KANAGARAJ, FARMINGTON HILLS, MI (US)

(73) Assignee: Panasonic Automotive Systems Company of America, Division of Panasonic Corporation of North America

(21) Appl. No.: 15/287,209

(22) Filed: Oct. 6, 2016

Related U.S. Application Data
(60) Provisional application No. 62/247,868, filed on Oct. 29, 2015.

(51) Int. Cl. H04R 1/02; H04R 1/08; G06F 3/16

(52) U.S. Cl. CPC H04R 1/025; G06F 3/165; H04R 1/08; H04R 2499/13

(57) ABSTRACT

A vehicle includes a first loudspeaker disposed on an outside of the vehicle adjacent to a driver's side window. A first microphone is disposed on an inside of the vehicle and is communicatively coupled to the first loudspeaker. A second loudspeaker is disposed on an inside of the vehicle. A second microphone is disposed on the outside of the vehicle adjacent to a driver's side window and is communicatively coupled to the second loudspeaker.

### CROSS-REFERENCED TO RELATED APPLICATIONS

This application claims benefit of U.S. Provisional Application No. 62/247,868 filed on Oct. 29 2015, which the disclosure of which is hereby incorporated by reference in its entirety for all purposes.

### FIELD OF THE INVENTION

The disclosure relates to the field of automotive communication systems, and, more particularly, to microphone and speaker systems on a vehicle.

### BACKGROUND OF THE INVENTION

It is known for a driver and passengers in a motor vehicle to converse with people outside of the vehicle by rolling down a window of the vehicle, such as when someone in the vehicle is ordering food in a drive-thru lane, or when someone is standing adjacent to the vehicle. However, rolling down the window allows outside cold or hot air, precipitation and car exhaust to enter the passenger compartment, which may have a deleterious effect on passengers' comfort or health. Another problem is that rolling down a window to talk to a stranger standing outside the window may allow the stranger to reach into the passenger compartment to commit a crime.

### SUMMARY

The present invention may include the use of a loudspeaker and microphone system that enables a person within a car to converse with a person outside the car, or converse with a fast food restaurant employee via a speaker and microphone combination at a drive thru menu board, without having to open a window of the vehicle. The vehicle may have a speaker and microphone within the passenger compartment, and another speaker and microphone outside the passenger compartment, such as on the driver's side view mirror. The inside microphone may be communicatively coupled to the outside speaker, and the outside microphone may be communicatively coupled to the inside speaker. Thus, a person speaking into the passenger compartment microphone can be heard through the outside speaker, and a person speaking into the outside microphone can be heard through the inside speaker.

The driver may be able to use a switch to shut off the inside microphone/outside speaker in order to protect the privacy of the vehicle passengers, and/or shut off the outside microphone/inside speaker to keep external noise out of the outside environment. The switches may be toggle switches or mute pushbuttons, for example.

The loudness of the inside speaker and outside speaker may be adjusted by one common volume knob or two respective volume knobs. The knobs may be connected to potentiometers, for example.

The inside microphone can be mounted in the sun visor above the driver, or on the steering wheel, for example.

In one embodiment, the invention comprises a vehicle including a first loudspeaker disposed on an outside of the vehicle adjacent to a driver's side window. A first microphone is disposed on an inside of the vehicle and is communicatively coupled to the first loudspeaker. A second loudspeaker is disposed on an inside of the vehicle. A second microphone is disposed on the outside of the vehicle adjacent to a driver's side window and is communicatively coupled to the second loudspeaker.

In another embodiment, the invention comprises a vehicle including a first loudspeaker disposed on an outside of the vehicle adjacent to a driver's side window. A first microphone is disposed on an inside of the vehicle. A second loudspeaker is disposed on an inside of the vehicle. A second microphone is disposed on the outside of the vehicle adjacent to a driver's side window. A communication bus communicatively couples the first loudspeaker to the first microphone and communicatively couples the second loudspeaker to the second microphone.

In yet another embodiment, the invention comprises a method of operating a motor vehicle, including providing a first loudspeaker disposed on an outside of the vehicle adjacent to a driver's side window. A first microphone disposed on an inside of the vehicle and communicatively coupled to the first loudspeaker is provided. A second loudspeaker disposed on an inside of the vehicle is provided. A second microphone disposed on the outside of the vehicle adjacent to a driver's side window and communicatively coupled to the second loudspeaker is provided.

The present invention has the advantage that a person within a car may quickly, comfortably, and safely converse with someone immediately outside the vehicle without having to roll down a window.

Another advantage is that the invention may eliminate the need to roll the window down and roll the window back up twice in order to go through a drive thru at a fast food restaurant (e.g., the first time to order the food, and the second time to receive the food), which can be particularly uncomfortable for the vehicle passengers during cold winter weather and during hot summer weather.

### BRIEF DESCRIPTION OF THE DRAWINGS

A better understanding of the present invention will be had upon reference to the following description in conjunction with the accompanying drawings.

FIG. 1 is a block diagram of one embodiment of an automotive audio communication arrangement of the present invention.

FIG. 2 is a flow chart of one embodiment of a method of the present invention for operating a motor vehicle.

### DETAILED DESCRIPTION OF THE PREFERRED EMBODIMENTS

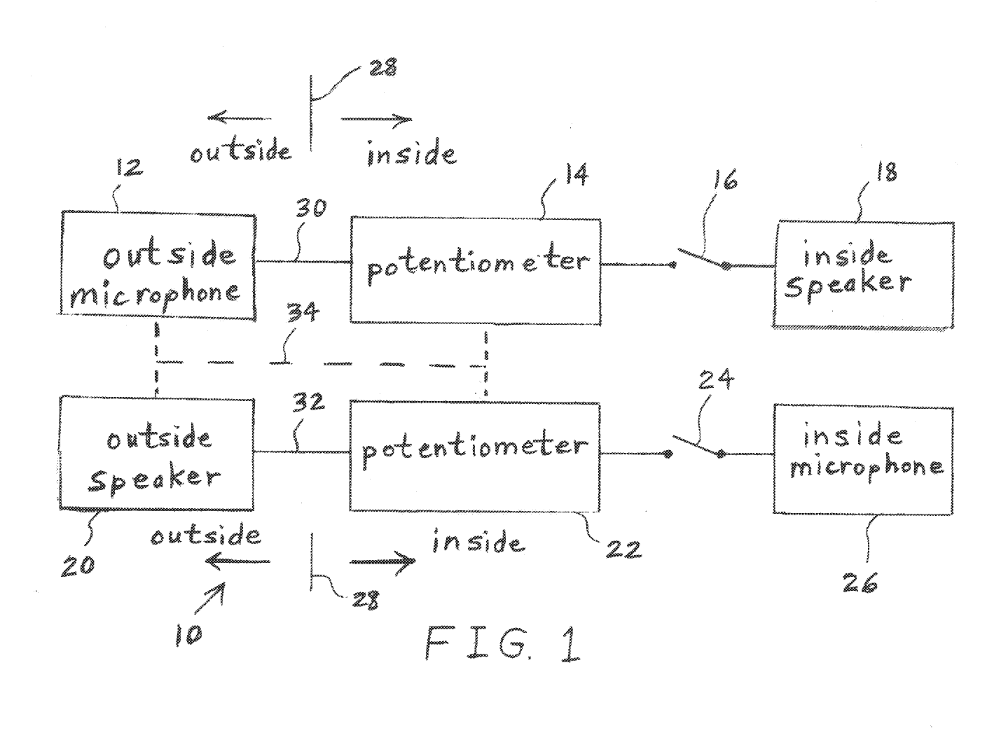

FIG. 1 illustrates one embodiment of an automotive audio communication arrangement 10 of the present invention including an outside microphone 12, an optional potentiometer 14, an optional mute switch 16, an inside speaker 18, an outside speaker 20, an optional potentiometer 22, an optional mute switch 24, and an inside microphone 26. Outside microphone 12 and outside speaker 20 may be disposed outside a driver's side window, indicated schematically at 28.

Potentiometers 14 and 22 may be adjusted by the user (e.g., by turning a knob) to turn up or turn down the volume of respective speakers 18, 20. Mute switches 16 and 24 may be toggled by the user to selectively mute or turn on respective speakers 18, 20. Potentiometers 14, 22 and mute switches 16, 24 may be disposed on a dashboard, console, steering wheel, or armrest of the vehicle.

Inside speakers 18 may be the same speaker that is used by the vehicle audio system to play the radio and sources of music. Inside microphone 26 may be disposed in a driver's sun visor, or the steering wheel, for example, for close proximity to the driver's mouth.

In one embodiment, outside microphone 12 is coupled to inside speaker 18 and potentiometer 14 through a communication bus or line 30 that is separate from a communication bus or line 32 that couples outside speaker 20 to inside microphone 26 and potentiometer 22. In an alternative embodiment, however, outside microphone 12 is coupled to inside speaker 18 and potentiometer 14 through a same communication bus or line 34 that couples outside speaker 20 to inside microphone 26 and potentiometer 22. In this alternative embodiment, communication lines 30, 32 may be omitted. In yet another embodiment, outside microphone 12 is wirelessly coupled to inside speaker 18 such that inside speaker 18 receives audio signals wirelessly; and inside microphone 26 is wirelessly coupled to outside speaker 20 such that outside speaker 20 receives audio signals wirelessly.

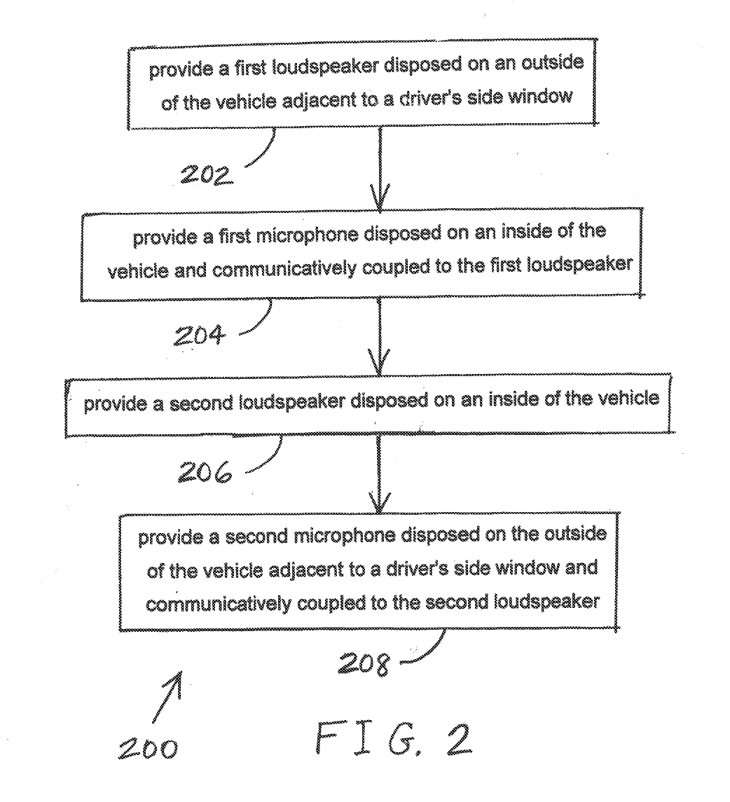

FIG. 2 illustrates one embodiment of a method 200 of the present invention for operating a motor vehicle. In a first step 202, a first loudspeaker is provided on an outside of the vehicle adjacent to a driver's side window. For example, outside speaker 20 may be provided outside the passenger compartment on the driver's side, such as on the side view mirror on the driver's side.

In a next step 204, a first microphone is provided on an inside of the vehicle such that the first microphone is communicatively coupled to the first loudspeaker. In the embodiment of FIG. 1, inside microphone 26 may be mounted on, or built into, a visor on the driver's side, or on the steering wheel, for example. Inside microphone 26 is in communication with outside speaker 20 such that sounds picked up by microphone 26 are audibly reproduced on outside speaker 20.

Next, in step 206, a second loudspeaker is provided on an inside of the vehicle. For example, inside speaker 18 may be installed in the vehicle dashboard, or in the door, facing the passenger compartment.

In a final step 208, a second microphone is provided on the outside of the vehicle adjacent to a driver's side window and is communicatively coupled to the second loudspeaker. In the embodiment of FIG. 1, outside microphone 12 may be provided outside the passenger compartment on the driver's side, such as on the side view mirror on the driver's side. Outside microphone 12 is in communication with inside speaker 18 such that sounds picked up by microphone 12 are audibly reproduced on inside speaker 18.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a first loudspeaker disposed on an outside of the vehicle adjacent to a driver's side window;
a first microphone disposed on an inside of the vehicle and communicatively coupled to the first loudspeaker;
a second loudspeaker disposed on an inside of the vehicle; and
a second microphone disposed on the outside of the vehicle adjacent to a driver's side window and communicatively coupled to the second loudspeaker.

2. The vehicle of claim 1 wherein the first loudspeaker is disposed on a driver's side view mirror of the vehicle.

3. The vehicle of claim 1 wherein the second microphone is disposed on a driver's side view mirror of the vehicle.

4. The vehicle of claim 1 wherein the second loudspeaker is configured to be used by a vehicle audio system for playing music.

5. The vehicle of claim 1 wherein the first microphone is disposed on a driver's side sun visor or on a steering wheel.

6. The vehicle of claim 1 further comprising a common communication bus communicatively coupling the first loudspeaker to the first microphone, and communicatively coupling the second loudspeaker to the second microphone.

7. The vehicle of claim 1 further comprising a manually operable control configured to adjust a loudness of at least one of the first loudspeaker and the second loudspeaker.

8. The vehicle of claim 1 further comprising a manually operable control configured to mute at least one of the first loudspeaker and the second loudspeaker.

9. A vehicle, comprising:
a first loudspeaker disposed on an outside of the vehicle adjacent to a driver's side window;
a first microphone disposed on an inside of the vehicle;
a second loudspeaker disposed on an inside of the vehicle;
a second microphone disposed on the outside of the vehicle adjacent to a driver's side window; and
a communication bus communicatively coupling the first loudspeaker to the first microphone and communicatively coupling the second loudspeaker to the second microphone.

10. The vehicle of claim 9 wherein the first loudspeaker is disposed on a driver's side view mirror of the vehicle.

11. The vehicle of claim 9 wherein the second microphone is disposed on a driver's side view mirror of the vehicle.

12. The vehicle of claim 9 wherein the second loudspeaker is configured to be used by a vehicle audio system for playing music.

13. The vehicle of claim 9 wherein the first microphone is disposed on a driver's side sun visor or on a steering wheel.

14. The vehicle of claim 9 further comprising a common communication bus communicatively coupling the first loudspeaker to the first microphone, and communicatively coupling the second loudspeaker to the second microphone.

15. The vehicle of claim 9 further comprising a manually operable control configured to adjust a loudness of at least one of the first loudspeaker and the second loudspeaker.

16. The vehicle of claim 9 further comprising a manually operable control configured to mute at least one of the first loudspeaker and the second loudspeaker.

17. A method of operating a motor vehicle, said method comprising:
providing a first loudspeaker disposed on an outside of the vehicle adjacent to a driver's side window;
providing a first microphone disposed on an inside of the vehicle and communicatively coupled to the first loudspeaker;
providing a second loudspeaker disposed on an inside of the vehicle; and
providing a second microphone disposed on the outside of the vehicle adjacent to a driver's side window and communicatively coupled to the second loudspeaker.

18. The method of claim 17 further comprising manually operating a control device to adjust a loudness of at least one of the first loudspeaker and the second loudspeaker.

19. The method of claim 17 further comprising manually operating a control device to mute at least one of the first loudspeaker and the second loudspeaker.

20. The method of claim 17 further comprising using the second loudspeaker to play commercial radio signals from a radio tuner of a vehicle audio system.
